(19) United States
(12) Patent Application Publication
(10) Pub. No.: US 2026/0234771 A1
(43) Pub. Date: Aug. 13, 2026

(54) STEEL WIRE ROD FOR TIRECORD HAVING EXCELLENT DRAWABILITY, PREPARATION METHOD THEREFOR, AND TIRECORD PREPARED BY USING SAME

(71) Applicant: Hyundai Steel Company, Incheon (KR)

(72) Inventors: Kyu Ho LEE, Incheon (KR); Jae Han Lim, Incheon (KR); Won Jin Choi, Incheon (KR); Jong Deok Kim, Incheon (KR)

(21) Appl. No.: 19/525,778

(22) PCT Filed: Jun. 4, 2024
(86) PCT No.: PCT/KR2024/007610

§ 371 Date: Apr. 3, 2026

(30) Foreign Application Priority Data
Jun. 30, 2023 (KR) 10-2023-0085230

(51) Int. Cl. C22C 38/16; B22D 11/00; B22D 11/113; B22D 11/116; B60C 9/00; C21D 7/13; C22C 38/00; C22C 38/02; C22C 38/04; C22C 38/06; C22C 38/08

(52) U.S. Cl. CPC C22C 38/16; B22D 11/001; B22D 11/113; B22D 11/116; B60C 9/0007; C21D 7/13; C22C 38/001; C22C 38/002; C22C 38/02; C22C 38/04; C22C 38/06; C22C 38/08; C21D 2211/005; C21D 2211/009

(57) ABSTRACT

The present invention relates to a steel wire rod for a tire cord, having excellent drawability, a preparation method therefor, and a tire cord prepared by using same, and implements a steel wire rod for a tire cord, having excellent drawability and 0.005 wt % or less of nitrogen (N), a preparation method therefor, and a tire cord prepared by using same, the steel wire rod comprising 0.70 to 0.95 wt % of carbon (C), 0.15 to 0.50 wt % of silicon (Si), 0.30 to 0.90 wt % of manganese (Mn), 0.015 wt % or less of phosphorus (P), 0.015 wt % or less of sulfur(S), 0.10 wt % or less of copper (Cu), 0.05 wt % or less of nickel (Ni), 0.010 wt % or less of aluminum (Al), and the remainder of iron (Fe) and other inevitable impurities.

### TECHNICAL FIELD

The present invention relates to a steel wire rod for a tire cord, having excellent drawability, a preparation method therefor, and a tire cord prepared by using same.

### BACKGROUND ART

A tire cord is a reinforcing material embedded in a rubber to enhance the stability, the drivability, and the durability of tires mounted on driving mechanisms, such as vehicles.

A material of the tire cord is broadly classified into a steel material and polymer synthetic fibers (polyester or nylon).

The steel tire cord is widely used recently because it has a higher strength and more excellent heat resistance than polymer synthetic fiber tire cord.

The steel tire cord is manufactured into an ultra-fine wire state by performing drawing and patenting heat treatment process on a steel wire rod. If the drawing process to the ultra-fine wire is performed, high work hardening is accompanied so that the sensitivity to surface defect, nitrogen content, and non-metallic inclusion is increased.

Accordingly, if a coarse non-metallic inclusion is in the steel wire rod, voids form at the interface between the inclusion and a matrix during the drawing, which consequently causes wire breakage during the drawing and stranding process.

If wire breakage occurs while manufacturing the tire cord, not only workability and productivity are degraded, but also a safety risk is caused so that the reduction of the frequency of wire breakage is a problem which should be solved.

Further, if a content of nitrogen is high, it adversely affects cold workability during the drawing process and causes a quality deterioration so that it is strictly managed to be 0.005 wt % or less.

In the meantime, electric furnace steel making is a method of manufacturing molten steel using scrap as a main raw material and electricity as a primary energy source. Blast furnace-converter steel making is a method of producing a molten iron by reducing iron ore in a blast furnace, transferring the molten iron to a steelmaking plant to manufacture a molten steel through molten iron pretreatment and converter process.

At this time, the molten iron produced in the blast furnace has a high content of carbon so that oxygen is blown during the converter process and carbon in the molten steel is removed through a decarburization reaction while blowing oxygen.

A larger amount of micro CO gas is generated in the molten steel due to the decarburization reaction and nitrogen is adsorbed and floats to the CO gas due to a partial pressure difference between the CO gas and molten steel to be removed together. A content of nitrogen in the molten steel is easily controlled during the decarburization reaction, which may produce a high-purity steel wire rod.

However, the electric furnace uses scrap as a main raw material so that a content of carbon in the molten steel is low and consequently, there is a problem in that a nitrogen removal effect through the decarburization reaction is inferior to the blast-converter operations.

In other words, the electric furnace has a disadvantage to control the nitrogen content to 0.005 wt % or less due to the characteristic of the manufacturing process. Due to this problem, as the steel wire rod for a tire cord, high-purity product produced through the blast furnace-converter process which easily controls the nitrogen content is being used.

Moreover, if a surface scale of the steel wire rod is large, there is a problem in that wire breakage is caused during the drawing and stranding, due to a residual scale which is not removed during a pickling process.

### DISCLOSURE

### Technical Problem

The present invention has been made an effort to solve the above-described problems and a technical object is to provide a steel wire rod for a tire cord, having excellent drawability and a preparation method therefor which minimize contents of coarse non-metallic inclusion and nitrogen, and a thickness of a surface scale through an electric furnace process and also reduce the frequency of wire breakage.

Further, a technical object of the present invention is to provide a tire cord which is produced using a steel wire rod for a tire cord having excellent drawability to minimize a frequency of wire breakage and satisfy a tensile strength of 3.2 GPa or higher.

Objects of the present invention are not limited to the above-mentioned objects, and other objects, which are not mentioned above, may be clearly understood by those skilled in the art from the following descriptions.

### Technical Solution

According to an aspect of the present invention, a steel wire rod for a tire cord having excellent drawability includes: 0.70 to 0.95 wt % of carbon (C), 0.15 to 0.50 wt % of silicon (Si), 0.30 to 0.90 wt % of manganese (Mn), 0.015 wt % or less of phosphorus (P), 0.015 wt % or less of sulfur(S), 0.10 wt % or less of copper (Cu), 0.05 wt % or less of nickel (Ni), 0.010 wt % or less of aluminum (Al), and the remainder of iron (Fe) and other inevitable impurities and includes 0.005 wt % or less of nitrogen (N). Desirably, 0.0033 to 0.0037 wt % of nitrogen (N) may be included.

According to an embodiment of the present invention, a thickness of a surface scale before pickling is 8 μm or smaller.

According to an embodiment of the present invention, a thickness of a decarburized layer is 0.05 mm or smaller.

According to an embodiment of the present invention, a cross-sectional shrinkage rate may be 30% or more.

According to an embodiment of the present invention, a total amount of non-metallic inclusion is 0.05 vol. % or less and a size of the inclusion is 40 μm or smaller.

According to an embodiment of the present invention, a tensile strength (TS) may be 1050 to 1250 MPa. If the tensile strength is less than 1050 MPa, the tensile strength of the tire cord prepared by the steel wire rod may be inferior. In contrast, if the tensile strength of the steel wire rod exceeds 1250 MPa, a load of rolling equipment is increased, which increases a frequency of wire breakage.

According to an embodiment of the present invention, a final refined structure includes ferrite and 90 vol. % or more of pearlite.

According to an aspect of the present invention, a preparation method for a steel wire rod for a tire cord having excellent drawability includes: a dissolution step (a) of dissolving a raw material; a vacuum degassing step (b) of processing a molten metal; a continuous casting step (c) of preparing a semi-finished product; and a hot rolling step (d) of hot rolling the semi-finished product. In the vacuum degassing step (b), a reflux flow rate of argon (Ar) is 900 to 1100 l/min, and the vacuum processing time is 20 minutes or longer.

According to an embodiment of the present invention, in the vacuum degassing step (b), a degree of vacuum is 2 mbar or lower.

According to an embodiment of the present invention, the steel wire rod which undergoes the hot rolling step (d) includes ferrite and 90 vol. % or more of pearlite in a final refined structure.

According to an embodiment of the present invention, in the steel wire rod which undergoes the hot rolling step (d), a thickness of a surface scale may be 8 μm or smaller.

According to an embodiment of the present invention, in the steel wire rod which undergoes the hot rolling step (d), a thickness of a decarburized layer may be 0.05 mm or smaller.

According to an embodiment of the present invention, the steel wire rod which undergoes the hot rolling step (d) may have a tensile strength (TS) of 1050 to 1250 MPa.

According to an embodiment of the present invention, in the steel wire rod which undergoes the hot rolling step (d), a total amount of non-metallic inclusion may be 0.05 vol. % or less.

According to an embodiment of the present invention, in the steel wire rod which undergoes the hot rolling step (d), a maximum size of non-metallic inclusion may be an average of 40 μm or smaller.

According to an embodiment of the present invention, the steel wire rod which undergoes the hot rolling step (d) includes 0.70 to 0.95 wt % of carbon (C), 0.15 to 0.50 wt % of silicon (Si), 0.30 to 0.90 wt % of manganese (Mn), 0.015 wt % or less of phosphorus (P), 0.015 wt % or less of sulfur(S), 0.10 wt % or less of copper (Cu), 0.05 wt % or less of nickel (Ni), 0.010 wt % or less of aluminum (Al), and the remainder of iron (Fe) and other inevitable impurities and includes 0.005 wt % or less of nitrogen (N).

According to an embodiment of the present invention, after the hot rolling step (d), a pickling step (e) may further be included.

A tire cord according to an embodiment of the present invention may be prepared using the steel wire rod which undergoes the pickling step (e)

### Advantageous Effects

A steel wire rod for a tire cord having excellent drawability according to an embodiment of the present invention and a preparation method therefor minimize a wire breakage rate which influences the drawability of the tire cord by controlling a size of a non-metallic inclusion while limiting a content of nitrogen through a degassing (RH) process.

Further, a steel wire rod for a tire cord having excellent drawability according to an embodiment of the present invention and a preparation method therefor minimize a thickness of a surface scale by controlling a winding temperature to shorten a surface pickling time and minimize a residual scale after the pickling while producing the tire cord.

Further, the tire cord according to an embodiment of the present invention is prepared using a steel wire rod for a tire cord having excellent drawability to implement a tensile strength of 3.2 GPa or higher.

The effects of the present invention are not limited to the aforementioned effects, and other effects, which are not mentioned above, will be apparently understood by a person skilled in the art from the recitations of the claims.

### DESCRIPTION OF DRAWINGS

FIG. 1 is a flowchart illustrating a preparation method of a steel wire rod for a tire cord having excellent drawability according to an embodiment of the present invention.

FIG. 2 is an enlarged photograph for explaining states of surface scales and residual scales after picking of steel wire rods according to Examples 5 and 6 and steel wire rods according to Comparative Examples 6 and 7.

### BEST MODE

Hereinafter, the present invention will be described more fully hereinafter with reference to the accompanying drawings, in which embodiments of the invention are shown. However, the present invention may be realized in various different forms, and is not limited to the exemplary embodiments described herein.

Further, when a component (or an area, a layer, or a portion) is described as being “placed on”, “connected to” or “coupled to” to another component, it should be understood that it may be directly placed on/connected to/coupled to the other component, but there may be another component therebetween.

It should be understood that a term “include” or “have” indicates that a feature, a number, a step, an operation, a component, a part or a combination thereof described in the specification is present, but do not exclude a possibility of presence or addition of one or more other features, numbers, steps, operations, components, parts or combinations thereof, in advance.

In order to clearly describe the present invention, detailed descriptions of parts which are unrelated to the description or well-known related technologies which may unnecessarily obscure the gist of the present invention will be omitted. Further, when reference numerals are denoted to components of each drawing in the present specification, throughout the specification, the same or like components are denoted by the same or like reference numerals.

Further, terms or words used in the specification and the claims should not be restrictively analyzed as a general and dictionary meaning and should be analyzed as a meaning and a concept which conform to the technical spirit of the present invention based on a principle that the inventor may appropriately define a concept of a term in order to describe his/her own invention by the most method.

Hereinafter, an embodiment of the present invention will be described in detail with reference to the drawings.

### Steel Wire Rod for Tire Cord Having Excellent Drawability

A steel wire rod for a tire cord having excellent drawability according to an embodiment of the present invention includes

0.70 to 0.95 wt % of carbon (C), 0.15 to 0.50 wt % of silicon (Si), 0.30 to 0.90 wt % of manganese (Mn), 0.015 wt % or less of phosphorus (P), 0.015 wt % or less of sulfur(S), 0.10 wt % or less of copper (Cu), 0.05 wt % or less of nickel (Ni), 0.010 wt % or less of aluminum (Al), and the remainder of iron (Fe) and other inevitable impurities and may include 0.005 wt % or less of nitrogen (N).

Hereinafter, a role and a content of each alloying element included in the steel wire rod for a tire cord having excellent drawability according to an embodiment of the present invention will be described in detail.

### Carbon (C)

Carbon (C) is an element effective to increase the strength, but there is a problem in that in accordance with the increase in the amount of carbon, the strength is improved, but toughness is degraded. Accordingly, a less content of carbon is desirable. To this end, in the steel wire rod for a tire cord having excellent drawability according to an embodiment of the present invention, if the content of carbon is less than 0.70 wt %, there is a problem in that the strength of the final tire cord is not ensured.

Further, if the content of carbon exceeds 0.95 wt % of a total weight, degradation of cross-sectional shrinkage rate may be caused together with the degradation of toughness and degradation in the drawability may be caused due to the formation of proeutectoid cementite.

### Silicon (Si)

Silicon (Si) is effective for increase in strength and deoxidation. If silicon is excessively added, toughness is degraded and the drawability is deteriorated due to the increased deformation resistance.

If a content of silicon is less than 0.15 wt %, it is difficult to ensure the deoxidation and strength. If the content of silicon exceeds 0.50 wt %, deformation resistance is increased and the drawability is degraded along with the degradation of toughness and it is difficult to remove the surface scale during the pickling and decarburization is accelerated.

Accordingly, the steel wire rod for a tire cord having excellent drawability according to the embodiment of the present invention may include 0.15 to 0.50 wt % of silicon.

### Manganese (Mn)

Manganese (Mn) is an element which increases the strength of the steel wire rod and is effective deoxidation and forms a MnS inclusion to suppress red-hot brittleness.

If the content of manganese is less than 0.3 wt %, deoxidation is degraded and it is difficult to ensure strength, and red-hot brittleness is caused.

In contrast, if the content of manganese exceeds 0.9 wt %, segregation is induced in the center of the steel wire rod and martensite may be formed upon cooling.

Accordingly, the steel wire rod for a tire cord having excellent drawability according to the embodiment of the present invention may include 0.3 to 0.9 wt % of manganese.

### Phosphorus (P)

Phosphorus (P) is a residual element that should be removed during the steelmaking process. If a content of phosphorus exceeds 0.015 wt %, brittleness may be caused by grain boundary segregation and the formation of Fe₃P compounds.

Accordingly, the steel wire rod for a tire cord having excellent drawability according to the embodiment of the present invention may include 0.015 wt % or less of phosphorus.

### Sulfur(S)

Sulfur(S) is a residual element that should be removed during the steelmaking process and forms MnS non-metallic inclusion.

If a content of sulfur exceeds 0.015 wt %, toughness is degraded due to excessive formation of sulfides such as MnS.

Accordingly, the steel wire rod for a tire cord having excellent drawability according to the embodiment of the present invention may include 0.015 wt % or less of sulfur.

### Copper (Cu)

Copper (Cu) is an element which contributes to strength increase of steel wire rod and improvement of corrosion resistance.

If a content of copper exceeds 0.10 wt %, when the steel wire rod is rolled at a high temperature, cracks of a surface is caused.

Accordingly, the steel wire rod for a tire cord having excellent drawability according to the embodiment of the present invention may include 0.10 wt % or less of copper.

### Nickel (Ni)

Nickel (Ni) is an element which contributes to strength increase of steel wire rod and improvement of corrosion resistance.

If a content of nickel exceeds 0.05 wt %, residual austenite is excessively formed to cause a reduced fatigue life and an increased manufacturing cost.

Accordingly, the steel wire rod for a tire cord having excellent drawability according to the embodiment of the present invention may include 0.05 wt % or less of nickel.

### Aluminum (Al)

Aluminum (Al) is an element serving as a strong deoxidizer and improves the toughness by the refinement of austenite grain size and forms a non-metallic inclusion.

If a content of aluminum exceeds 0.01 wt %, coarse aluminum based non-ductile inclusion is excessively formed to cause wire breakage during drawing.

Accordingly, the steel wire rod for a tire cord having excellent drawability according to the embodiment of the present invention may include 0.01 wt % or less of aluminum.

### Nitrogen (N)

Nitrogen (N) is bonded with an element, such as aluminum (Al), titanium (Ti), vanadium (V), or niobium (Nb) to form precipitates and is effective to refine the grain size of austenite.

If a content of nitrogen exceeds 0.005 wt %, precipitates are excessively formed to cause deviation in the strength and adversely affect the cold-rolling processability during the drawing process.

Accordingly, the steel wire rod for a tire cord having excellent drawability according to the embodiment of the present invention may include 0.005 wt % or less of nitrogen, and more desirably, 0.0033 to 0.0037 wt %.

A balance other than the above-described components of steel may include Fe and inevitable impurities. The inevitable impurities are impurities mixed during a steelmaking step and a manufacturing process of an electrical steel sheet and are widely known in the art so that a detailed description thereof will be omitted.

In the embodiment of the present invention, addition of an element other than the above-described alloying constituents is not excluded, but various elements may be included without departing from the technical spirit of the present invention. When an additional element is further included, Fe which is the balance may be replaced.

In the steel wire rod for a tire cord having excellent drawability according to an embodiment of the present invention, a total amount of non-metallic inclusion is 0.05 vol. % or less and a maximum size of the non-metallic inclusion is an average of 40 μm or smaller.

Desirably, a total amount of non-metallic inclusion is 0.021 to 0.025 vol. % and a maximum size of the non-metallic inclusion may be 17.1 to 17.3 μm.

Consequently, according to the embodiment of the present invention, a total amount of a non-metallic inclusion, a maximum size of the non-metallic inclusion, and a nitrogen content are controlled in a predetermined range to significantly reduce a frequency of wire breakage which is caused during the manufacturing process of a tire cord.

Further, according to an embodiment of the present invention, an average thickness of a surface scale of a steel wire rod before pickling to be described below may be 8 μm or smaller, and desirably 7.2 μm or smaller.

Accordingly, a residual scale on the surface of the steel wire rod is completely removed after the pickling, so that the frequency of wire breakage may be further reduced.

According to an embodiment of the present invention, a thickness of a decarburized layer may be controlled to 0.05 mm or smaller.

Further, according to the embodiment of the present invention, as an evaluation result of a tensile strength test, a cross-sectional shrinkage rate of the steel wire rod may be 30% or more.

The steel wire rod for a tire cord having excellent drawability according to an embodiment of the present invention may have a tensile strength (TS) of 1050 to 1250 MPa.

Further, the steel wire rod for a tire cord having excellent drawability according to the embodiment of the present invention may include 90 vol. % or more of pearlite and ferrite in a final refined structure. However, the final refined structure of the steel wire rod is not limited as described above and structures other than ferrite may be included.

Hereinafter, a preparation method for a steel wire rod for a tire cord having excellent drawability according to an embodiment of the present invention will be described in detail.

### Preparation Method for Steel Wire Rod for Tire Cord Having Excellent Drawability

Hereinafter, a preparation method for a steel wire rod for a tire cord having excellent drawability according to an embodiment of the present invention will be described.

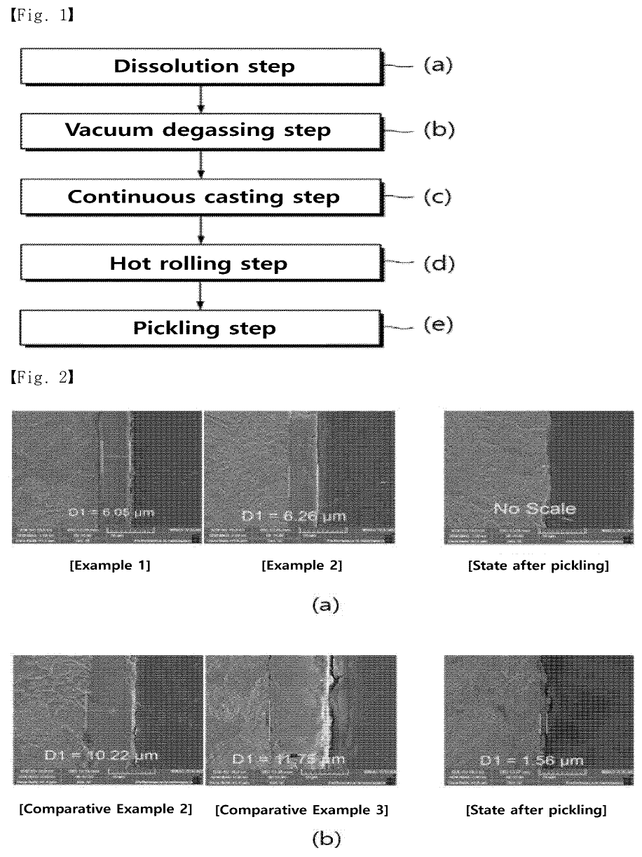

FIG. 1 is a flowchart illustrating a preparation method of a steel wire rod for a tire cord having excellent drawability according to an embodiment of the present invention.

The preparation method of a steel wire rod for a tire cord having excellent drawability according to an embodiment of the present invention includes a dissolution step (a) of dissolving a raw material, a vacuum degassing step (b) of processing molten metal, a continuous casting step (c) of manufacturing a semi-finished product, a hot rolling step (d) of hot-rolling the semi-finished product, and a pickling step (e) of processing a surface of a hot-rolled product.

According to an embodiment of the present invention, in the dissolution step (a), a raw material is charged in a melting furnace to produce molten metal. In the embodiment, the melting furnace is an electric furnace.

Generally, electric furnace steel making is a method of manufacturing molten steel using scrap as a main raw material and electricity as a primary energy source.

In contrast, blast furnace-converter steel making is a method of producing a molten iron by reducing iron ore in a blast furnace, transferring the molten iron to a steelmaking plant to manufacture a molten steel through molten iron pretreatment and converter process.

Since molten iron has a high carbon content, oxygen is blown in during the converter process, and carbon in the molten steel may be removed through a decarburization reaction when oxygen is blown. At this time, a larger amount of micro CO gas is generated in the molten steel due to the decarburization reaction and nitrogen is adsorbed and floats to the CO gas due to a partial pressure difference between the CO gas and molten steel to be removed together.

However, the electric furnace uses scrap as a main raw material so that a content of carbon in the molten steel is low and consequently, there is a problem in that a nitrogen removal effect through the decarburization reaction is inferior the blast-converter operations.

In order to solve this problem in the preparation method of a steel wire rod for a tire cord having excellent drawability according to the embodiment of the present invention, an optimal condition of the vacuum degassing step (b) was derived to reduce a maximum size of the non-metallic inclusion and a nitrogen content which served as a quality degradation factor when the tire cord was prepared through the electric furnace operation.

According to the embodiment of the present invention, in the vacuum degassing step (b), a molten steel produced in the electric furnace is processed. Specifically, in the vacuum degassing step (b), a reflux flow rate of argon (Ar) is 900 to 1100 l/min, and the vacuum processing time is 20 minutes or longer. At this time, a degree of vacuum of the vacuum degassing step (b) is controlled to be 2 mbar or lower.

Desirably, in the vacuum degassing step (b), a reflux flow rate of argon (Ar) is 1008 to 1056 l/min, and the vacuum processing time in the vacuum degassing step is 25 to 26 minutes.

If a tire cord was prepared with a steel wire rod prepared under the above-described process condition, it was confirmed that a frequency of wire breakage was significantly reduced as compared with the related art.

According to an embodiment of the present invention, in the continuous casting step (c), a molten metal which undergoes the vacuum degassing step (b) is prepared as a semi-finished product. In the present embodiment, the semi-finished product may be billet. However, it is not limited thereto and the semi-finished product may be prepared in the form of slabs or blooms

According to an embodiment of the present invention, the hot rolling step (d) includes a step of reheating the semi-finished product, a step of hot rolling the semi-finished product, and a step of including the semi-finished product. Specifically, billets are reheated at a temperature of 1000 to 1150° C. for 90 minutes or longer. After precisely rolling the reheated billet at a precise rolling entry temperature of 850 to 1000° C., the reheated billet is wound at a winding temperature of 800 to 870° C.

In the preparation method of a steel wire rod for a tire cord having excellent drawability according to an embodiment of the present invention, the billet may be reheated for 90 minutes or longer during the rolling process.

Further, a thickness of a decarburized layer may be controlled to be 0.05 mm or smaller through the hot rolling process as described above.

If a reheating temperature of billet exceeds 1150° C., a decarburized layer is excessively formed on the surface, which may cause degradation of a quality of a tire cord product. In contrast, if the reheating temperature is lower than 1000° C., a load of rolling equipment is increased to cause defects, such as cobbles during the rolling, which may degrade a rolling productivity.

If a precise rolling entry temperature exceeds 1000° C., it is not easy to satisfy a winding process condition to reduce a thickness of a surface scale. In contrast, if the precise rolling entry temperature is lower than 850° C., a load of the rolling equipment is increased, which may cause a surface defect, such as rolling folding. Accordingly, the precise rolling entry temperature is desirably controlled to 850 to 1000° C.

If the winding temperature exceeds 870° C., a thickness of the surface scale is increased so that even though the prepared steel wire rod is subject to pickling, the scales remain locally, which causes the wire breakage during the drawing and stranding processes. In contrast, if the winding temperature is lower than 800° C., big difference from the rolling temperature occurs, which may cause a defect in a winding shape.

For example, if the winding temperature reaches 881 to 933° C., a thickness of the surface scale is 9 to 12 μm so that the surface scale remains even after pickling so that it is not appropriate as a tire cord to perform the pickling process.

According to the embodiment of the present invention, in the pickling step (e), a pickling solution is sprayed on a product after the hot rolling step to remove the surface scale.

The steel wire rod for a tire cord prepared by the above-described preparation steps includes 0.005 wt % or less of nitrogen, and more desirably, 0.0033 to 0.0037 wt %.

Further, in the steel wire rod for a tire cord, a total amount of a non-metallic inclusion is 0.05 vol. % or less and a maximum size of the non-metallic inclusion may be average of 40 μm or less. Desirably, a total amount of non-metallic inclusion is 0.021 to 0.025 vol. % and a maximum size of the non-metallic inclusion is 17.1 to 17.3 μm.

Accordingly, according to the embodiment of the present invention, a total amount of a non-metallic inclusion, a maximum size of the non-metallic inclusion, and a nitrogen content are controlled in a predetermined range to significantly reduce a frequency of wire breakage which is caused during the manufacturing process of a tire cord.

According to the preparation method of a steel wire rod for a tire cord having excellent drawability according to an embodiment of the present invention, a surface scale having a thickness of 8 μm or smaller is formed to be completely removed after the pickling and a picking operation time is shortened.

According to an embodiment of the present invention, a thickness of a decarburized layer may be controlled to 0.05 mm or smaller.

Further, the steel wire rod according to the preparation method may have 30% or more of a cross-sectional shrinkage rate.

The steel wire rod according to the preparation method may have a tensile strength (TS) of 1050 to 1250 MPa.

The steel wire rod according to the preparation method may have a final refined structure formed by ferrite and 90 vol. % or more of pearlite.

### Tire Cord

A tire cord according to an embodiment of the present invention is prepared through a series of preparation processes including a surface pickling process using the steel wire rod, a dry drawing process which processes to a diameter of 1 to 2 mm, a patenting thermal treatment process, a brass plating process, a wet drawing process which processes to a diameter of 0.15 to 0.40 mm, and a stranding process.

The tire cord according to an embodiment of the present invention uses a steel wire rod having excellent drawability to minimize the frequency of wire breakage, thereby satisfying a tensile strength of 3.2 GPa or higher.

### Comparative Example and Example

Hereinafter, desirable Examples and Comparative Examples are proposed for better understanding of the present invention. However, the following Examples and Comparative Examples are provided to help the understanding of the present invention, but the present invention is not limited by the following examples.

In Comparative Examples and Examples, a raw material with the same quality was dissolved in an electric furnace to be prepared as a billet through a continuous casting process under the same condition, but a condition of only a specific process (a vacuum degassing step and a hot rolling step) was different.

Table 1 represents a degassing process condition which prepared specimens of Examples and Comparative Examples, Table 2 represents a measurement result of each specimen which was implemented according to a degassing process condition of Table 1, Table 3 represents a rolling process condition which prepared specimens of Examples and Comparative Examples, and Table 4 represents a measurement result of each specimen which was implemented according to a rolling process condition of Table 3.

In the meantime, in Table 2, a total amount of non-metallic inclusion was measured by JIS G0555 specification test method and specifically, a steel wire rod of each specimen was cut longitudinally and a proportion of a non-metallic inclusion which occupied an intersection of the grid was represented by percentage (%) using a microscope.

In Table 4, a maximum thickness of a surface scale was obtained by observing a cross-section of each specimen with a microscope and measuring a circumferential thickness of iron oxide at a boundary of a matrix structure including ferrite and pearlite.

TABLE 1

Vacuum degassing process condition

| Classifi- | Reflux flow rate of | Vacuum processing |
|---|---|---|
| cation | argon (Ar) (l/min) | time (min) |
| EX. 1 | 910 | 21 |
| EX. 2 | 1008 | 25 |
| EX. 3 | 1056 | 26 |
| EX. 4 | 1093 | 27 |
| COMP. EX. 1 | 850 | 17 |
| COMP. EX. 2 | 880 | 21 |
| COMP. EX. 3 | 1125 | 19 |
| COMP. EX. 4 | 1191 | 23 |

TABLE 2

| | | | | Frequency of |
|---|---|---|---|---|
| | Total amount | Maximum | | wire breakage |
| | of non- | size of | | during |
| | metallic | non-metallic | Nitrogen | manufacturing |
| Classifi- | inclusion (vol. %, | inclusion | content | tire cord |
| cation | JIS G0555) | (μm) | (wt %) | (numbers/coil) |
| EX. 1 | 0.033 | 21.6 | 0.0045 | 1 |
| EX. 2 | 0.021 | 17.1 | 0.0037 | Not observed |
| EX. 3 | 0.025 | 17.3 | 0.0033 | Not observed |
| EX. 4 | 0.029 | 33.2 | 0.0028 | 2 |
| COMP. | 0.062 | 52.8 | 0.0064 | 6 |
| EX. 1 | | | | |
| COMP. | 0.051 | 53.6 | 0.0051 | 7 |
| EX. 2 | | | | |
| COMP. | 0.054 | 45.7 | 0.0049 | 6 |
| EX. 3 | | | | |
| COMP. | 0.059 | 49.1 | 0.0035 | 5 |
| EX. 4 | | | | |

According to Tables 1 and 2, during the degassing process of Examples 1 to 4, a vacuum processing time was controlled to 21 minutes, 25 minutes, 26 minutes, and 27 minutes while controlling a reflux flow rate of argon (Ar) to 910 l/min, 1008 l/min, 1056 l/min, and 1093 l/min.

In contrast, as the degassing process condition of Comparative Examples 1 to 4, in the vacuum degassing process, a vacuum processing time was controlled to 17 minutes, 21 minutes, 19 minutes, and 23 minutes while controlling a reflux flow rate of argon (Ar) to 850 l/min, 880 l/min, 1125 l/min, and 1191 l/min.

As a result, total amounts of non-metallic inclusions of Examples 1 to 4 were 0.033 vol. %, 0.021 vol. %, 0.025 vol. %, and 0.029 vol. %, respectively. In contrast, total amounts of non-metallic inclusions of Comparative Examples 1 to 4 were 0.062 vol. %, 0.051 vol. %, 0.054 vol. %, and 0.059 vol. %, respectively, so that it was confirmed to be significantly increased as compared with Examples 1 to 4.

Further, maximum sizes of non-metallic inclusions of Examples 1 to 4 were 21.6 μm, 17.1 μm, 17.3 μm, and 33.2 μm. In contrast, maximum sizes of non-metallic inclusions of Comparative Examples 1 to 4 were 52.8 μm, 53.6 μm, 45.7 μm, and 49.1 μm, respectively, so that it was confirmed to be much bulkier than those of Examples 1 to 4.

Further, nitrogen contents of Examples 1 to 4 were 0.0045 wt %, 0.0037 wt %, 0.0033 wt %, and 0.0028 wt %, respectively. In contrast, nitrogen contents of Comparative Examples 1 to 4 were 0.0064 wt %, 0.0051 wt %, and 0.0035 wt %, respectively, so that it was confirmed to be much bulkier than those of Examples 1 to 4.

When the tire cord was prepared using the steel wire rods for a tire cord of Examples 1 to 4 and the steel wire rods for a tire cord of Comparative Examples 1 to 4, a frequency of wire breakage which represented the number of wire breakages per coil was measured.

As a measurement result, when the tire cord was prepared using the steel wire rods for a tire cord of Examples 1 to 4, it was measured as once/coil, zero/coil (not observed), zero/coil (not observed), and twice/coil.

In contrast, when the tire cord was prepared using the steel wire rods for a tire cord of Comparative Examples 1 to 4, it was measured as 6 times/coil, 7 times/coil, 6 times/coil, and 5 times/coil.

Referring to Tables 1 and 2, during the vacuum degassing step, if one or more of the Argon reflux flow rate and the vacuum processing time is out of a predetermined range, it is confirmed that a total amount of a non-metallic inclusion is increased, a maximum size of a non-metallic inclusion is increased, or a nitrogen content is increased so that the frequency of wire breakage is increased during the manufacturing of the tire cord.

TABLE 3

| | Reheating | | Winding |
|---|---|---|---|
| Classifi- | temperature | Precise rolling entry | temperature |
| cation | (° C.) | temperature (° C.) | (° C.) |
| EX. 1 | 1010 | 866 | 811 |
| EX. 2 | 1059 | 921 | 827 |
| EX. 3 | 1081 | 943 | 853 |
| EX. 4 | 1137 | 980 | 868 |
| COMP. EX. 1 | 1022 | 873 | 881 |
| COMP. EX. 2 | 1088 | 925 | 920 |
| COMP. EX. 3 | 1121 | 998 | 933 |
| COMP. EX. 4 | 1051 | 922 | 940 |

TABLE 4

| | Maximum thickness of | Presence of residual |
|---|---|---|
| Classification | surface scale (μm) | scale after pickling |
| EX. 1 | 6.1 | No |
| EX. 2 | 6.3 | No |
| EX. 3 | 6.8 | No |
| EX. 4 | 7.2 | No |
| COMP. EX. 1 | 9.3 | Yes |
| COMP. EX. 2 | 10.2 | Yes |
| COMP. EX. 3 | 11.8 | Yes |
| COMP. EX. 4 | 12.2 | Yes |

According to Tables 3 and 4, in Examples 1 to 4, rolling reheating temperatures were controlled to 1010° C., 1059° C., 1081° C., and 1137° C. and precise rolling entry temperatures were controlled to 866° C., 921° C., 943° C., and 980° C. Further, the winding temperatures were controlled to 811° C., 827° C., 853° C., and 868° C.

In contrast, in Comparative Examples 1 to 4, rolling reheating temperatures were controlled to 1022° C., 1088° C., 1121° C., and 1051° C., precise rolling entry temperatures were controlled to 873° C., 925° C., 998° C., and 922° C., and the winding temperatures were controlled to 881° C., 920° C., 933° C., and 940° C., respectively.

Upon examination, in Examples 1 to 4, maximum thickness of surface scales was measured by 6.1 μm, 6.3 μm, 6.8 μm, and 7.2 μm.

In contrast, in Comparative Examples 1 to 4, maximum thickness of surface scales was measured by 9.3 μm, 10.2 μm, 11.8 μm, and 12.2μ m.

At this time, if it was checked whether there were residual scales of the steel wire rods according to Examples 1 to 4 and the steel wire rods according to Comparative Examples 1 to 4 after the pickling process, it was confirmed that no residual scales were found from the steel wire rods according to Examples 1 to 4 and residual scales with a significant thickness remained in the steel wire rods according to Comparative Examples 1 to 4.

FIG. 2 is an enlarged photograph illustrating a surface scale and a residual scale after pickling of a steel wire rod according to Examples 1 and 2 and a steel wire rod according to Comparative Examples 2 and 3.

Referring to FIG. 2, in the steel wire rods according to Examples 1 and 2, it was understood that maximum thicknesses (D1) of the surface scales were 6.1 μm and 6.3 μm, respectively, but the surface scales were completely removed after pickling so that no residual scale was found.

In contrast, in the steel wire rods according to Comparative Examples 1 and 2, it was confirmed that maximum thicknesses (D1) of the surface scales were 10.22 μm and 11.75 μm, respectively, so that the surface scales were not completely removed after pickling and residual scales remained.

Referring to Tables 3 and 4 and FIG. 2, in Examples 1 to 4 in which the winding temperature is 870° C. or lower, a thickness of the surface scale is formed to be small so that the surface scale is completely removed after the pickling. However, in Comparative Examples 1 to 4 in which the winding temperature exceeds 870° C., a thickness of the surface scale is formed to be large so that the residual scale remains even after the pickling.

As described above, the exemplary embodiments of the present invention have been described and it is obvious to those skilled in the art that the present invention may be embodied in other specific forms other than Comparative Examples and Examples which have been described above, without departing from the spirit or scope of the present invention. Therefore, it should be understood that the embodiment is not restrictive, but is illustrative and thus the present invention is not limited to the above-described embodiment but may be modified within the scope of the accompanying claims and the equivalent range.

1. A steel wire rod for a tire cord having excellent drawability, comprising:
0.70 to 0.95 wt % of carbon (C), 0.15 to 0.50 wt % of silicon (Si), 0.30 to 0.90 wt % of manganese (Mn), 0.015 wt % or less of phosphorus (P), 0.015 wt % or less of sulfur(S), 0.10 wt % or less of copper (Cu), 0.05 wt % or less of nickel (Ni), 0.010 wt % or less of aluminum (Al), and the remainder of iron (Fe) and other inevitable impurities and includes 0.005 wt % or less of nitrogen (N).

2. The steel wire rod for a tire cord having excellent drawability of claim 1, wherein 0.0033 to 0.0037 wt % of nitrogen (N) is included.

3. The steel wire rod for a tire cord having excellent drawability of claim 1, wherein a thickness of a surface scale before pickling is 8 μm or smaller.

4. The steel wire rod for a tire cord having excellent drawability of claim 1, wherein a thickness of a decarburized layer is 0.05 mm or smaller.

5. The steel wire rod for a tire cord having excellent drawability of claim 1, wherein a cross-sectional shrinkage rate is 30% or more.

6. The steel wire rod for a tire cord having excellent drawability of claim 1, wherein a total amount of non-metallic inclusion is 0.05 vol. % or less and a size of the inclusion is 40 μm or smaller.

7. The steel wire rod for a tire cord having excellent drawability of claim 1, wherein a tensile strength (TS) is 1050 to 1250 MPa.

8. The steel wire rod for a tire cord having excellent drawability of claim 1, wherein a final refined structure includes ferrite and 90 vol. % or more of pearlite.

9. A preparation method for a steel wire rod for a tire cord having excellent drawability comprising:
a dissolution step (a) of dissolving a raw material;
a vacuum degassing step (b) of processing a molten metal;
a continuous casting step (c) of preparing a semi-finished product; and
a hot rolling step (d) of hot rolling the semi-finished product,
wherein in the vacuum degassing step (b), a reflux flow rate of argon (Ar) is 900 to 1100 l/min, and the vacuum processing time is 20 minutes or longer.

10. The preparation method for a steel wire rod for a tire cord having excellent drawability of claim 9, wherein in the vacuum degassing step (b), a degree of vacuum is 2 mbar or lower.

11. The preparation method for a steel wire rod for a tire cord having excellent drawability of claim 9, wherein the steel wire rod which undergoes the hot rolling step (d) includes ferrite and 90 vol. % or more of pearlite in a final refined structure.

12. The preparation method for a steel wire rod for a tire cord having excellent drawability of claim 9, wherein in the steel wire rod which undergoes the hot rolling step (d), a thickness of a surface scale is 8 μm or smaller.

13. The preparation method for a steel wire rod for a tire cord having excellent drawability of claim 9, wherein in the steel wire rod which undergoes the hot rolling step (d), a thickness of a decarburized layer is 0.05 mm or smaller.

14. The preparation method for a steel wire rod for a tire cord having excellent drawability of claim 9, wherein the steel wire rod which undergoes the hot rolling step (d) has a tensile strength (TS) of 1050 to 1250 MPa.

15. The preparation method for a steel wire rod for a tire cord having excellent drawability of claim 9, wherein in the steel wire rod which undergoes the hot rolling step (d), a total amount of non-metallic inclusion is 0.05 vol. % or less.

16. The preparation method for a steel wire rod for a tire cord having excellent drawability of claim 9, wherein in the steel wire rod which undergoes the hot rolling step (d), a maximum size of non-metallic inclusion is an average of 40 μm or smaller.

17. The preparation method for a steel wire rod for a tire cord having excellent drawability of claim 9, wherein the steel wire rod which undergoes the hot rolling step (d) includes 0.70 to 0.95 wt % of carbon (C), 0.15 to 0.50 wt % of silicon (Si), 0.30 to 0.90 wt % of manganese (Mn), 0.015 wt % or less of phosphorus (P), 0.015 wt % or less of sulfur(S), 0.10 wt % or less of copper (Cu), 0.05 wt % or less of nickel (Ni), 0.010 wt % or less of aluminum (Al), and the remainder of iron (Fe) and other inevitable impurities and includes 0.005 wt % or less of nitrogen (N).

18. The preparation method for a steel wire rod for a tire cord having excellent drawability of claim 9, further comprising:
after the hot rolling step (d), a pickling step (e).

19. A tire cord prepared using the steel wire rod which undergoes the pickling step (e) according to the method of claim 18.
